(19) United States
(12) Patent Application Publication
(10) Pub. No.: US 2010/0209650 A1
(43) Pub. Date: Aug. 19, 2010

(54) Building board

(75) Inventor: Werner Schlueter, Iserlohn (DE)

Correspondence Address: COLLARD & ROE, P.C., 1077 NORTHERN BOULEVARD, ROSLYN, NY, 11576, US

(73) Assignee: Schlueter-Systems KG

(21) Appl. No.: 12/657,747

(22) Filed: Jan. 27, 2010

(30) Foreign Application Priority Data
Feb. 18, 2009 (DE) 20 2009 002 298.6

(51) Int. Cl. B32B 33/00; B32B 3/26; E04C 2/20

(52) U.S. Cl. 428/41.7; 428/158; 428/159; 52/309.4

(57) ABSTRACT

A building board as a carrier for a surface cladding of tiles, a plaster or a thin-layer trowel mortar has a moisture-resistant foam core layer which is provided on both sides with a paper or plastic film web on which a fibre material web made of nonwoven fabric or a knitted or machine-knitted fabric defining the outer side of the building board is disposed. The building board is provided with at least one groove which extends from a face side of the building board to the opposing face side of the building board, and largely penetrates the foam core layer from an outer side of the building board.

The invention relates to a building board as a carrier for a surface cladding of tiles, a plaster or a thin-layer trowel mortar.

A wide variety of embodiments of this type of building board are known in the prior art.

For example, building boards are known wherein a board made of moisture-resistant foam is coated on both sides with cement mortar and a coarse woven grid in order to provide the necessary reinforcement.

From DE 92 00 687.6 U1 building boards are also known wherein the is foam core layer is made of polyurethane with a closed-cell outer skin which is, for example, 25 mm thick. Foamed onto the visible side of this foam core layer is a web of glass fibre nonwoven fabric, the foam penetrating through the nonwoven fabric web.

A similar building board as a sandwich structure wherein a nonwoven fabric web is also foamed onto the foam core layer is known from DE 19 27 794 U. Another web made of an air- and water vapour-permeable material can also be disposed here between the covering layers made of nonwoven fabric and the foam core layer, for example made of a mesh structure or a network, it being possible to adhesively bond this intermediate layer.

Furthermore, known from DE 199 40 423 C2 is an insulating board, in particular for cladding an outer wall of a building or as a tile carrier in wet room construction, having a board-type insulation layer made of a foamed or poured insulating material, a woven fleece being foamed or poured onto the surface on one or both sides of this foam core layer as a carrier material for an external plaster or a tile mortar, thus forming a covering layer.

In order to produce an outer or inner corner with these types of building board it is known to cut the abutting face sides of two building boards at an angle, for example respectively at an angle of 45°, in order to produce a 90° corner so that the face sides of the building boards can be arranged cleanly abutting one another and adhesively bonded to one another. However, a relatively large amount of time is required for this.

In order to eliminate this problem it is known, furthermore, to not only chamfer, but also to adhesively bond building boards at the factory so that finished building board corner parts are produced. Accordingly, the time-consuming adhesive bonding on site is dispensed with. However, it is a disadvantage with these types of building board corner part produced at the factory that the latter are very cumbersome and are accordingly difficult to package and transport.

In order to clad or produce surfaces provided with curves, which for example columns, spiral-shaped shower installations or similar have, up till now one has used building boards of the type specified at the start is which are already provided with the required curve at the factory. However, it is a disadvantage with these building boards that due to the pre-specified curve, the latter can not be used flexibly. In addition, due to their curvature they take up a lot of space, and so they are very difficult to package and transport.

Starting with this prior art it is an object of the present invention to provide building boards with a moisture-resistant foam core layer with which one can produce corners and/or curves without any problem. In addition, the building board according to the invention should be easy to package and transport.

In order to achieve this object the present invention provides a building board as a carrier for a surface cladding of tiles, a plaster or a thin-layer trowel mortar having a moisture-resistant foam core layer which is provided on both sides with a paper or plastic film web on which a fibre material web made of nonwoven fabric or a knitted or machine-knitted fabric defining the outer side of the building board is disposed, the building board being provided with at least one groove which extends from a face side of the building board to the opposing face side of the building board, and largely penetrates, and preferably totally penetrates the foam core layer from an outer side of the building board. Along this groove the building board can be bent or folded to one or the other side, the paper or plastic film web and the fibre material web, through which the groove does not pass, following this folding or bending movement flexibly, and thus furthermore holding together the building board. Before the building board is folded or bent along the groove to the intended degree, the groove can be filled at least partially with adhesive, for example with tile adhesive, in order to fix the newly established shape of the building board.

According to one embodiment of the present invention the at least one groove has a substantially V-shaped cross-section so that corresponding corners can be produced, the cut edges preferably enclosing an angle within the range of 60 to 135°, in particular 90°.

Advantageously, disposed along at least one cut edge of the groove is at least one adhesive strip the outwardly directed adhesive surface of which is covered with a removeable protective film strip. Correspondingly, the cut edges abutting one another in the bent or folded state can be connected to one another with the aid of the adhesive strip if the protective film strip has previously been removed.

According to a further embodiment of the present invention the at least one groove has a substantially rectangular cross-section, the width of the groove preferably coming within a range of between 1 and 10 mm.

Advantageously, a plurality of grooves are provided which are preferably respectively disposed parallel to one another.

In particular, grooves with a substantially rectangular cross-section are advantageously spaced apart from one another by equal distances, preferably by distances within the range of 1.5-6 cm. In this way a wide variety of curves can be produced with the building board, as is described in greater detail below by means of an exemplary embodiment.

According to a further embodiment of the present invention, a grid web made of a coarse mesh grid or a coarse mesh fabric is disposed between the paper or plastic film web and the fibre material web. By incorporating this grid web additional reinforcement of the building board is achieved.

The foam core layer is preferably moisture-tight in order to rule out any penetration of moisture. The paper or plastic film web should be water-resistant, in particular water-tight, in order to prevent any damage in a damp environment.

At least one of the fibre material webs, in particular the one through which the at least one groove does not pass, is advantageously provided with an imprinted or impressed grid which serves as an aid to cutting. By means of this grid adaptation of the building board dimensions are simplified for a user. These building boards are generally initially rectangular structures, and so the lines of the grid advantageously extend parallel to the side edges. In order to avoid arduous cutting, the lines can additionally be provided with dimensional details.

In the following two embodiments of the present invention are described in greater detail with reference to the attached drawings. These show as is follows:

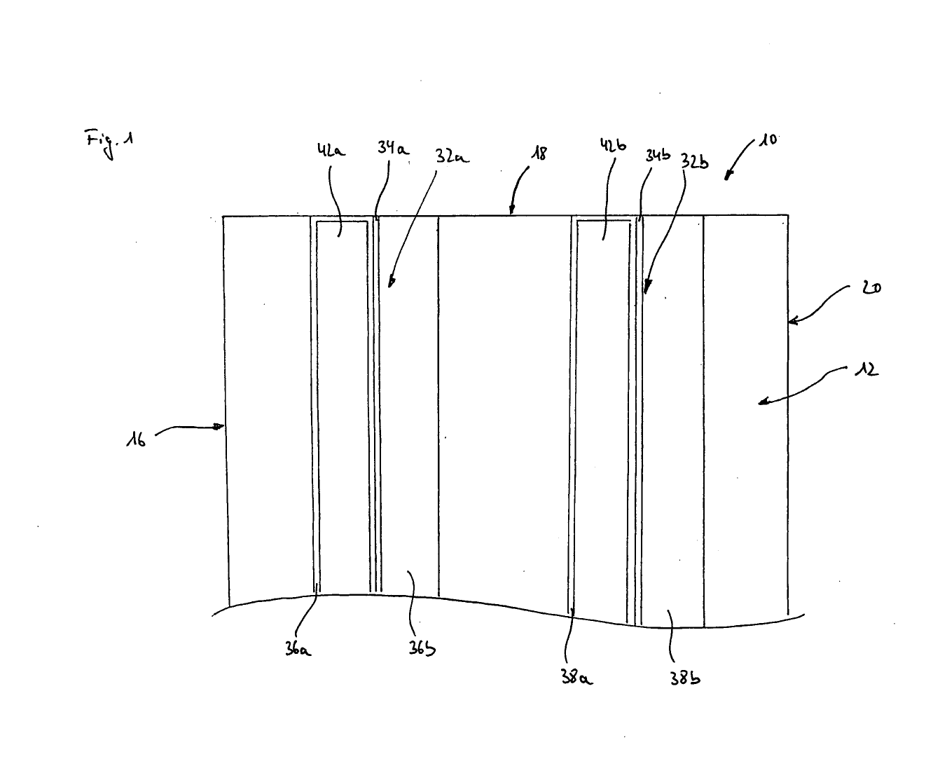

FIG. 1 a top view of a building board according to a first embodiment of the present invention in the unbent state;

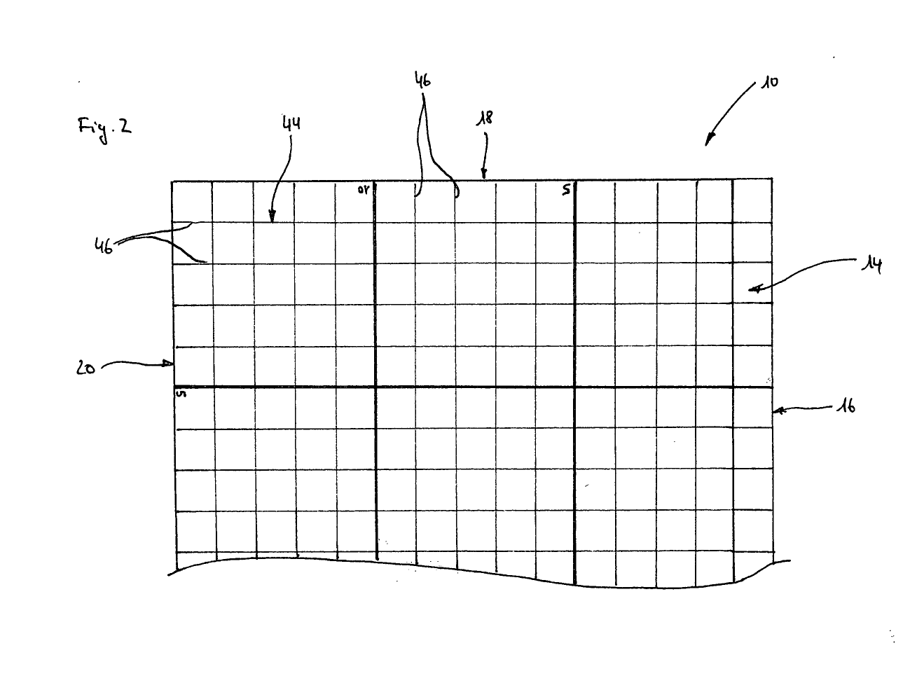

FIG. 2 a bottom view of the building board illustrated in FIG. 1;

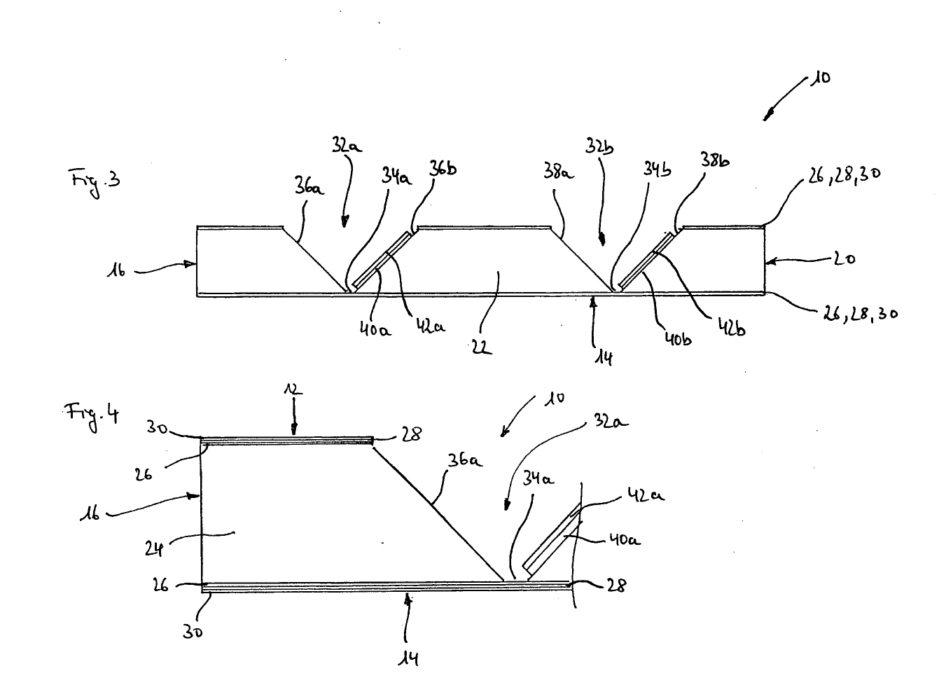

FIG. 3 a side view of the building board illustrated in FIG. 1;

FIG. 4 a partially sectioned and enlarged side view according to FIG. 2;

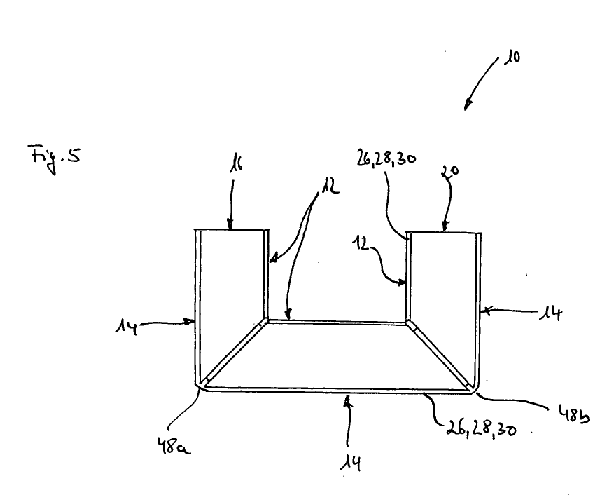

FIG. 5 a side view of the building board illustrated in FIG. 1 in the bent state;

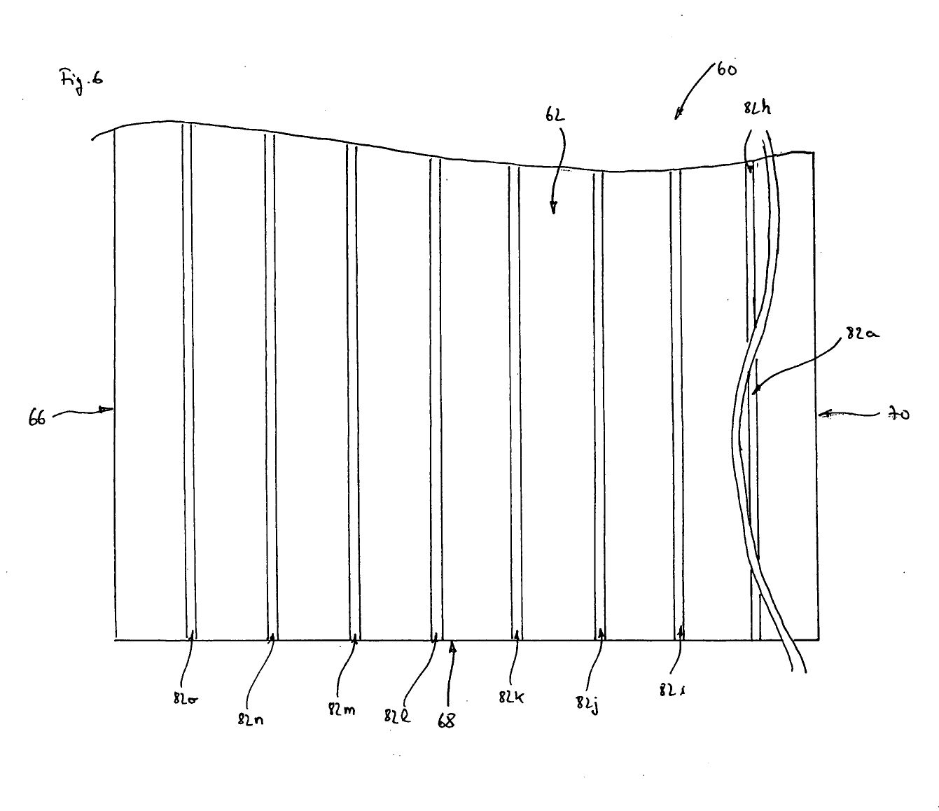

FIG. 6 a top view of a building board according to a second embodiment of the present invention in the unbent state;

FIG. 7 a side view of the building board illustrated in FIG. 5;

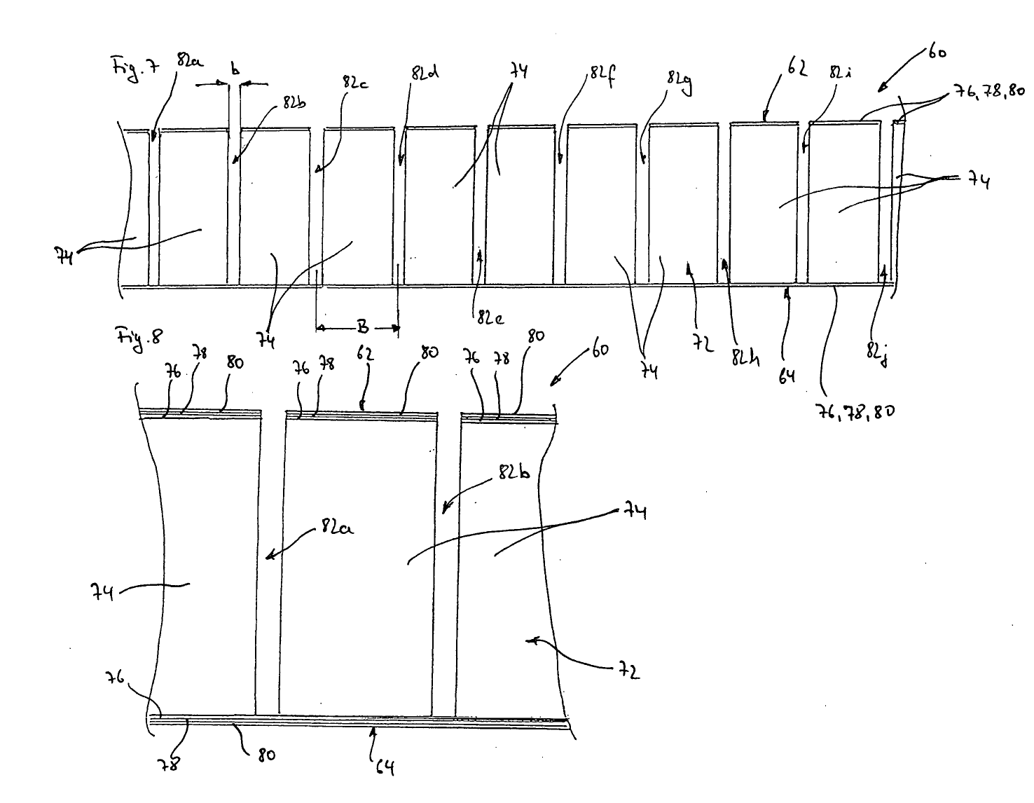

FIG. 8 a cut and enlarged side view according to FIG. 6;

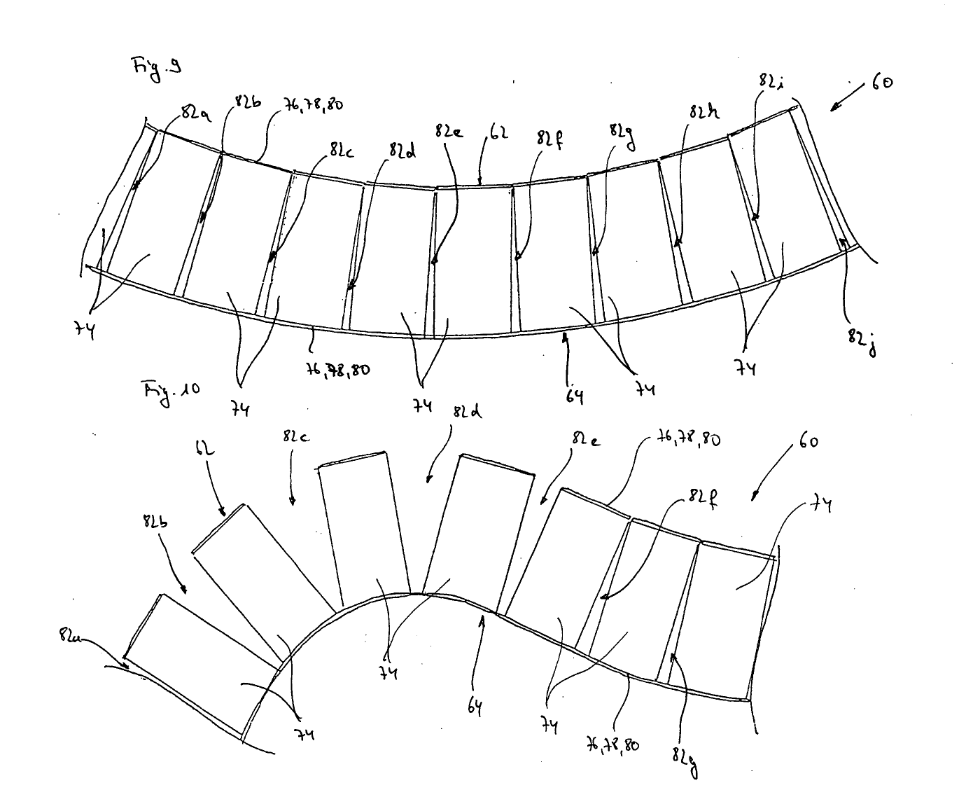

FIG. 9 a side view of the building board illustrated in FIGS. 5-7 in a first bent state, and

FIG. 10 a side view of the building board illustrated in FIGS. 5-7 in a second bent state.

The building board 10 illustrated in FIGS. 1 to 5 according to a first embodiment of the present invention serves as a carrier for a surface cladding of tiles, a plaster or a thin-layer trowel mortar. The building board 10 is rectangular in form and comprises an upper side 12, a lower side 14 and four building board face sides 16, 18, 20 and 22.

As is illustrated in particular in the enlarged view of FIG. 4, the building board 10 is made of a moisture-tight foam core layer 24 on which a paper or plastic film web 26 is provided on both sides. Disposed in turn on each of the paper or plastic film webs 26 is a grid web 28 made of a coarse mesh grid or a coarse mesh fabric which serves to provide additional reinforcement of the building board 10. The grid webs 28 are respectively covered with a fibre material web 30 made of nonwoven fabric or a knitted or machine-knitted fabric which define the upper side 12 and the lower side 14 of the building board 10.

From the upper side 12 two grooves 32a and 32b are made in the building board 10 which extend respectively from the face side of the building board 18 to the opposing face side of the building board 22, and from the top side 12 of the building board 10 totally penetrate the foam core layer 24. Therefore, the building board 10 is only held together at the respective groove base 34a and 34b by the paper or plastic film web 26, the grid web 28 and the fibre material web 30. Each of the grooves 32a and 32b has a V-shaped cross-section, the cut edges 36a, b and 38a, b of the respective grooves 32a and 32b extending at an angle a of 90° in relation to one another. Attached respectively to the cut edges 36b and 38b of the grooves 32a and 32b is an adhesive strip 40a and 40b, the outwardly directed adhesive surface of which is covered by a removeable protective film strip 42a and 42b.

On the lower side 14 of the building board 10 an imprinted or impressed grid 44 is provided which serves as a cutting aid for a user if the building board 10 still needs to be cut to size on site. The grid 44 is formed by a plurality of grid lines 46 extending parallel to the face sides of the building board 18 and 22, and 16 und 20, in the present case every fifth grid line 46 being thicker than the other grid lines 46 in order to facilitate user orientation as regards distances. Furthermore, every fifth grid line 46 is provided with a figure, such as for example “5”, “10” etc., which represents a longitudinal dimension, such as for example 5 cm, 10 cm, etc.

An advantage of the building board 10 is that provided the latter is in the unbent state, as shown for example in FIG. 3, it is very easy to package and transport due to its level extension. At the construction site the protective strips 42a and 42b can then be pulled off, and the cut edges 36a, b and 38a, b can be bent round along the corresponding groove base 34a and 34b so that the cut edges 36a and 36b, and 38a and 38b of the grooves 32a and 32b, which are then abutting one another, can be adhesively bonded to one another. Correspondingly the arrangement illustrated in FIG. 5 is produced.

A further advantage of the building board 10 is that the lower side 14, even in the bent state as shown in FIG. 5, and even in the corner regions 48a and 48b, forms a continuous, and so clean surface. In other words, the lower side 14 is not damaged due to the flexibility and pliability of the paper or plastic film web 26, the grid web 28 and the fibre material web 30. The water-resistance and water-tightness of the paper or plastic film web 26 is also maintained.

It should be clear that any spacing and any shape is possible for the grooves 32a and 32b. Therefore, for example, an angle a different from 90° can be chosen. Furthermore, it should be clear that instead of two grooves, just one groove or more than two grooves can also be provided.

FIGS. 6 to 10 show a building board 60 according to a second embodiment of the present invention which serves as a carrier for a surface cladding of tiles, a plaster or a thin-layer trowel mortar. The building board 60 is rectangular in form and comprises an upper side 62, a lower side 64 and four building board face sides 66, 68, 70 und 72.

As is illustrated in particular in the enlarged view of FIG. 8, the building board 60 has a water-tight foam core layer 74 on which a paper or plastic film web 76 is provided on both sides. In turn, a grid web 78 made of a coarse mesh grid or a coarse mesh fabric is respectively attached to the paper or plastic film webs 76. The grid webs 78 are covered with a fibre material web 80 made of nonwoven fabric or a knitted or machine-knitted fabric which define the upper side 12 and the lower side 14 of the building board 10.

Starting from the upper side 12 of the building board 10 a plurality of grooves 82a, b, c, etc. are made in the building board 60 which extend from the face side of the building board 72 to the opposing face side of the building board 68 and totally or at least largely penetrate the foam core layer 74 from the upper side 62 of the building board 60.

The grooves 82a, b, c, etc. respectively have a rectangular cross-section, the groove width b preferably coming within a range of between 1 and 10 mm. The grooves 82a, b, c, etc. are spaced apart from one another by equal distances, in this case by distances B in the range from 1.5 to 6 cm.

Similarly to the building board 10, the building board 60 can also be provided on its lower side 64 with an imprinted or impressed grid which is not illustrated here, however.

In the state shown in FIG. 7, the building board 60 can be packaged and transported without any problem due to its level extension.

On the construction site a user can then bend the building board 60 as he pleases dependently upon the number, the size and the spacings of the grooves 82a, b, c, etc., as shown for example in FIGS. 9 and 10, by means of which a wide variety of curves can be produced. As soon as the user has bent the building board 60 into the desired shape, the gaps of the respective grooves 82a, b, c, etc. can be filled with an adhesive, in particular with tile adhesive, in order in this way to fix the curve generated. One essential advantage of the building board 60 is that due to the flexibility and pliability of the paper or plastic film web 76, the grid web 78 and the fibre material web 80, a continuous surface is always produced along the lower side 64 of the building board 60, by means of which further processing is substantially facilitated for the user. The water-resistance and water-tightness of the paper or plastic film web 76 is also maintained.

It should be clear that any number, size and spacings can be chosen for the individual grooves 82a, b, c, etc.

s Furthermore, it should be clear that with the building boards 10 and 60 one can dispense with the grid webs 28 and 78.

### LIST OF REFERENCE NUMBERS

10 Building board
12 Upper side
14 Lower side
16 Face side
18 Face side
20 Face side
22 Face side
24 Foam core layer
26 Paper or plastic film web
28 Grid web
30 Fibre material web
32a, b Grooves
34a, b Groove bases
36a, b Cut edges
38a, b Cut edges
40a, b Adhesive strip
42a, b Protective strip
44 Grid
46 Grid lines
48a, b Corner regions
60 Building board
62 Upper side
64 Lower side
66 Face side
68 Face side
70 Face side
72 Face side
74 Foam core layer
76 Paper or plastic film web
78 Grid web
80 Fibre material web
82a, b, c etc. Grooves

1. A building board (10; 60) as a carrier for a surface cladding of tiles, a plaster or a thin-layer trowel mortar having a moisture-resistant foam core layer (24; 74) which is provided on both sides with a paper or plastic film web (26; 76) on which a fibre material web (30; 80) made of nonwoven fabric or a knitted or machine-knitted fabric defining the outer side of the building board is disposed, the building board (10; 60) being provided with at least one groove (32a, b; 82a, b, c . . . ) which extends from a face side of the building board (18; 68) to the opposing face side of the building board (22; 72), and largely penetrates the foam core layer (24; 74) from an outer side (12; 62) of the building board (10; 60).

2. The building board (10; 60) according to claim 1, wherein the at least one groove (32a, b; 82a, b, c . . . ) totally penetrates the foam core layer (24; 74) from an outer side (12; 62) of the building board (10; 60).

3. The building board (10) according to claim 1, wherein the at least one groove (32a, b) has a substantially V-shaped cross-section, the cut edges (36a, b; 38a, b) preferably enclosing an angle (á) within the range of 60 to 135°, in particular 90°.

4. The building board (10) according to claim 3, wherein disposed along at least one cut edge (36a, b) of the groove (32a, b) is an adhesive strip (40a, b) the outwardly directed adhesive surface of which is covered with a removeable protective film strip (42a, b).

5. The building board (60) according to claim 1, wherein the at least one groove (82a, b, c . . . ) has a substantially rectangular cross-section, the width of the groove (b) preferably coming within a range of between 1 and 10 mm.

6. The building board (10; 60) according to claim 1, wherein a plurality of grooves (32a, b; 82a, b, c . . . ) are provided.

7. The building board (10; 60) according to claim 6, wherein the grooves (32a, b; 82a, b, c . . . ) are respectively disposed parallel to one another.

8. The building board (10; 60) according to claim 7, wherein the grooves (32a, b; 82a, b, c . . . ) are spaced apart from one another by equal distances (B), in particular by distances (B) within the range of 1.5 to 6 cm.

9. The building board (10; 60) according to claim 1, wherein a grid web (28; 78) made of a coarse mesh grid or a coarse mesh fabric is disposed between the paper or plastic film web (26; 76) and the fibre material web (30; 80).

10. The building board (10; 60) according to claim 1, wherein the foam core layer (24; 74) is moisture-tight.

11. The building board (10; 60) according to claim 1, wherein the paper or plastic film web (26; 76) is water-resistant, in particular water-tight.

12. The building board (10; 60) according to claim 1, wherein at least one of the fibre material webs (30; 80) is provided with an imprinted or impressed grid (44) as an aid to cutting.
